(19) United States
(12) Patent Application Publication
(10) Pub. No.: US 2015/0292702 A1
(43) Pub. Date: Oct. 15, 2015

(54) Rotary Electromagnetic Actuator and Car Lamp Low Beam and High Beam Light Switching Device Thereof

(71) Applicant: SHANGHAI KOITO AUTOMOTIVE LAMP CO., LTD., Shanghai (CN)

(72) Inventors: Shijie Yu, Shanghai (CN); Minghua Zhu, Shanghai (CN); Tianzhong Guo, Shanghai (CN); Yujie Chen, Shanghai (CN)

(73) Assignee: SHANGHAI KOITO AUTOMOTIVE LAMP CO., LTD., Shanghai (CN)

(21) Appl. No.: 14/425,984

(22) PCT Filed: Sep. 5, 2013
(86) PCT No.: PCT/CN2013/082970

§ 371 Date: Mar. 4, 2015

(30) Foreign Application Priority Data
Sep. 7, 2012 (CN) 201210330728.1

(51) Int. Cl. F21S 8/10

(52) U.S. Cl. CPC F21S 48/1778

(57) ABSTRACT

A rotary electromagnetic actuator and a car lamp low beam and high beam light switching device. The rotary electromagnetic actuator, comprising a shell, a rotor, a stator, a rotating shaft and an end cover; a stator winding is arranged on the stator, and the stator is fixedly installed at the inner part of the shell to form a pair of arc-shaped stator magnetic poles on which electric excitation can be applied; the rotor, as an arc-shaped permanent magnet, is fixed on the rotating shaft and is located in a magnetic field space of the arc-shaped magnetic poles of the stator; and the rotor is matched with the arc-shaped stator magnetic poles to form an air gap closing magnetic path; an swing bar extending along radial direction of the rotating shaft is connected to two ends of the rotating shaft respectively; the light screen of the car lamp low beam and high beam light switching device is fixedly connected on the swing bars at two ends of the rotating shaft; and a swing angle of the light screen is identical with a rotating angle of the rotor.

### Field of the Invention

The invention relates to a lighting device or function characteristics or spare parts of its system, in particular to a rotary electromagnetic actuator used for changing characteristics and distribution of light by means of adjusting spare parts, and a car lamp low beam and high beam light switching device thereof.

### BACKGROUND OF THE INVENTION

A driver is easy to meet and climbing or getting down the slope in driving. Particularly, when a vehicle is driven at nighttime, light of opposite vehicle and the reflection light of pavement in the course of climbing or getting down the slope will influence the visual sense of the driver; in case that the light is too strong, driver cannot see the road in the front clearly, so driver is required to switch the car lamp low beam and high beam light of the vehicle timely, otherwise, traffic accident will be happened. Therefore, the modern vehicle can realize the low beam and high beam light switching control of the automobile by widely applying the switching mechanism of the headlamp; the electromagnetic actuator (solenoid valve) is widely applied to the switching mechanism of the headlamp. The headlamp switching can be realized by using the absorption and resilience of electromagnet in the electromagnetic actuator (solenoid valve), and its action is relatively reliable.

The Chinese utility model “improvement of car lamp low beam and high beam light switching device” (patent number of utility model: ZL 200720129230.3; authorized announcement number: CN201089421Y) discloses an improvement of the car lamp low beam and high beam light switching device, wherein said fixing blade is arranged at the front edge of a reflection mirror body, and the adjusting device includes a solenoid valve and a moving blade; the solenoid valve is provided with a moving rod used for connecting with the moving blade, and the moving blade is connected with the fixing blade by a pivoting component, and used for taking the pivoting component as the rotating shaft; the moving blade is extended with a connecting arm in perpendicular to the moving blade body, and used for connecting with the moving bar of the solenoid valve; the solenoid valve of the adjusting device is arranged at the side of the reflection mirror body, and the pivoting component is used as the rotating shaft of the moving blade, so that the power consumption of the solenoid valve can be reduced; it is good for reducing the heat energy of the solenoid valve, and reducing the degree of temperature rise.

The Chinese utility model “improvement of low beam and high beam light switching device for the automotive headlamp” (patent number of utility model: ZL 200720129230.3; authorized announcement number: CN201089421Y) discloses a low beam and high beam light switching device for the automotive headlamp, which is mainly composed of a fixing light screen, a moveable light screen, a rotating shaft, a rotating shaft spacing gasket, an electromagnetic iron and a connecting linear. The switching function component of the low beam and high beam light of the utility model is simple in structure, easy to produce and assemble, rapid in switching reaction, and good in light screen; moreover, it can more efficiently and safely switch the low beam and high beam light, and improve the driving safety.

However, in practice application, some users complain about the big collision noise during the actuation and release of the electromagnet in the existing electromagnetic actuator. Under the environment of stressing on the user's comfort level, it is very necessary to reduce noise when the rotary electromagnetic actuator is worked. Besides, the electromagnet will generate strong shock during the actuation and release, and also easy to cause the light-shaped jittering; moreover, this shock will cause loose connection and other failure, and influence the reliability of the low beam and high beam light switching device.

### SUMMARY OF THE INVENTION

The invention aims to provide a rotary electromagnetic actuator used for the car lamp low beam and high beam light switching device; by changing the movement form of the electromagnetic actuator, the technical problem of big noise can be solved when the low beam and high beam light switching device.

The technical plan adopted to solve the technical problem in this invention is:

A rotary electromagnetic actuator, comprising a shell, a rotor, a stator, a rotating shaft and an end cover, and a light screen used for driving a car lamp low beam and high beam light switching device, wherein:

a stator winding is arranged on the stator, and the stator and the stator winding are fixedly mounted in the shell to form a pair of arc-shaped stator magnetic poles on which electric excitation can be applied;

the rotor, as an arc-shaped permanent magnet, is fixed on the rotating shaft and is located in a magnetic field space of the arc-shaped magnetic poles of the stator; and the rotor is matched with the arc-shaped stator magnetic poles to form an air gap closing magnetic path;

an swing bar extending along radial direction of the rotating shaft is connected to two ends of the rotating shaft respectively; the light screen of the car lamp low beam and high beam light switching device is fixedly connected on the swing bars at two ends of the rotating shaft; and a swing angle of the light screen is identical with a rotating angle of the rotor.

A good technical plan of the rotary electromagnetic actuator of the invention, which is characterized in that the rotor of the electromagnetic actuator is rotatably fixed in the magnetic field space of the arc-shaped magnetic poles of the stator through a shaft hole on the end cover; under an uncharged state, the rotor stops on an initial position where the permanent magnet is relative to one of the magnetic poles of the stator; and under a charged state, the rotor rotates to an acting position where the permanent magnet is relative to the pair of the magnetic poles of the stator under the function of a magnetic field generated by the stator winding.

A better technical plan of the rotary electromagnetic actuator of the invention, characterized in that the permanent magnet of the rotor is integrated with the rotating shaft and the swing bar through injection moulding.

The other one purpose of the invention is to provide a car lamp low beam and high beam light switching device using the rotary electromagnetic actuator; through changing the movement form of the electromagnetic actuator, the movement method of the whole car lamp low beam and high beam light switching device is changed, thereby the technical problem of big noise can be solved when the car lamp low beam and high beam light switching device.

The technical plan adopted to solve the technical problem of the invention is:

A car lamp low beam and high beam light switching device, comprising a light screen, a electromagnetic actuator, and a bracket fixed on the lamp body, wherein:

the electromagnetic actuator is the rotary electromagnetic actuator; both ends of the rotating shaft of the electromagnetic actuator are respectively connected with one swing bar extended along the radial direction of the rotating shaft;

the rotary electromagnetic actuator is fixedly connected to the bracket through the shell, and connected to the lamp body through the bracket;

the light screen is fixedly connected to the swing bar, and placed on the light axial line of the lamp; the included angle between the light screen and the light axial line can be changed along with the rotating angle of the rotor; the outline of the light screen is projected on the road to form the light model of the low beam and high beam light changed along with the rotor.

A good technical plan of the car lamp low beam and high beam light switching device, characterized in that the light screen is welded with the rotating shaft and the swing bar into one.

A better technical plan of the car lamp low beam and high beam light switching device of the invention, characterized by comprising a scroll spring and a spring component consisting of spring frames; the spring component is fixed on the bracket through the spring frame, a free end of the scroll spring is connected to the light screen; under an uncharged state, the rotor is returned and kept at the initial position under the action of the scroll spring through the transmission of the swing bar and the rotating shaft.

Beneficial effect of this invention is:

1. The rotary electromagnetic actuator and the car lamp low beam and high beam light switching device thereof provided by the invention can realize the car lamp low beam and high beam light switching through the method of driving the light screen by the rotary electromagnetic actuator, avoid big collision noise generated by the actuation and release of the electromagnet, and provide a more comfortable driving environment for users;

2. The rotary electromagnetic actuator and the car lamp low beam and high beam light switching device thereof provided by the invention drive the light screen by adopting the rotary electromagnetic actuator, avoid the light-shaped jittering caused by shock in the course of actuation and release of the electromagnet, and loose connection caused by this shock, thereby improving the service life and reliability of the car lamp low beam and high beam light switching device of the rotary electromagnetic actuator;

3. The rotary electromagnetic actuator and the car lamp low beam and high beam light switching device thereof provided by the invention realize the car lamp low beam and high beam light switching by adopting the rotary electromagnetic actuator to replace the electromagnet; it has bigger adjusting routine of the light screen, and can avoid the light screening phenomenon of the light screen at the place closing to the pivoting point; therefore, it can enlarge the light-shaped adjusting scale under the basis of not adding the boundary dimension of the electromagnetic actuator, thereby reducing the limit of the internal space of the lamp to the car lamp low beam and high beam light switching device.

### BRIEF DESCRIPTION OF DRAWINGS

FIG. 1 is a structural representation of the car lamp low beam and high beam light switching device adopting the rotary electromagnetic actuator of the invention;

FIG. 2 is the external structure diagram of the rotary electromagnetic actuator of the invention;

FIG. 3 is the internal structure diagram of the rotary electromagnetic actuator of the invention;

FIG. 4 is the structural representation that the rotary electromagnetic actuator of the invention drives the light screen to rotate to the action position;

FIG. 5 is the schematic diagram of the car lamp low beam and high beam light switching device that the light screen is rotated to the action position;

FIG. 6 is the schematic diagram of decomposition of the assembling relationship of the car lamp low beam and high beam light switching device of the invention. Sign of every part in the figures above: 1-lamp body (reflection mirror), 2-light screen, 3-spring component, 301-scroll spring, 302-spring frame, 4- electromagnetic actuator, 5-bracket, 401-shell, 402-rotor (permanent magnet), 403-stator, 404-stator winding, 405-rotating shaft, 406-swing bar, 407-end cover, 408-shaft hole.

### DETAIL DESCRIPTION OF THE INVENTION

In order to better understand the technical plan of the invention, the below will further describe in details by referring to the attached drawings and embodiments.

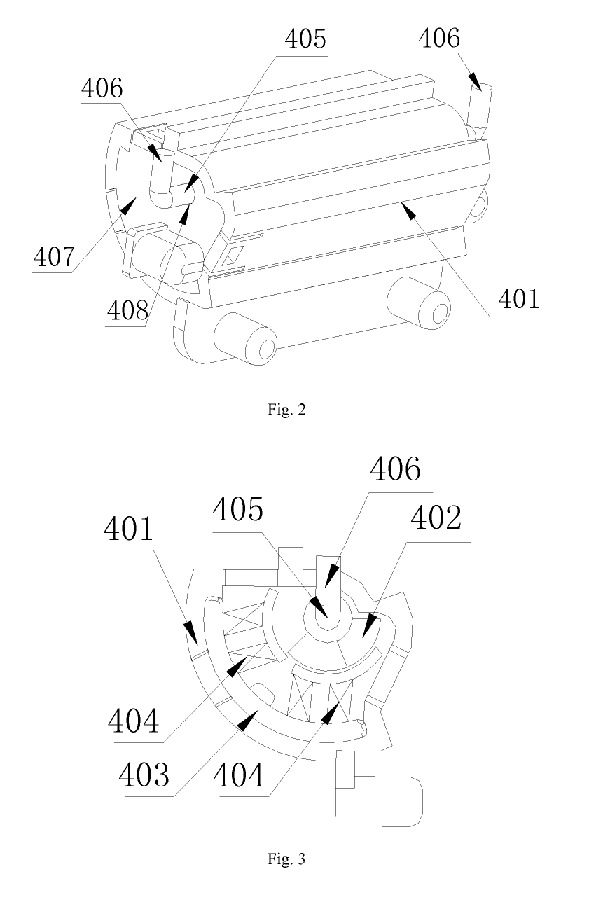

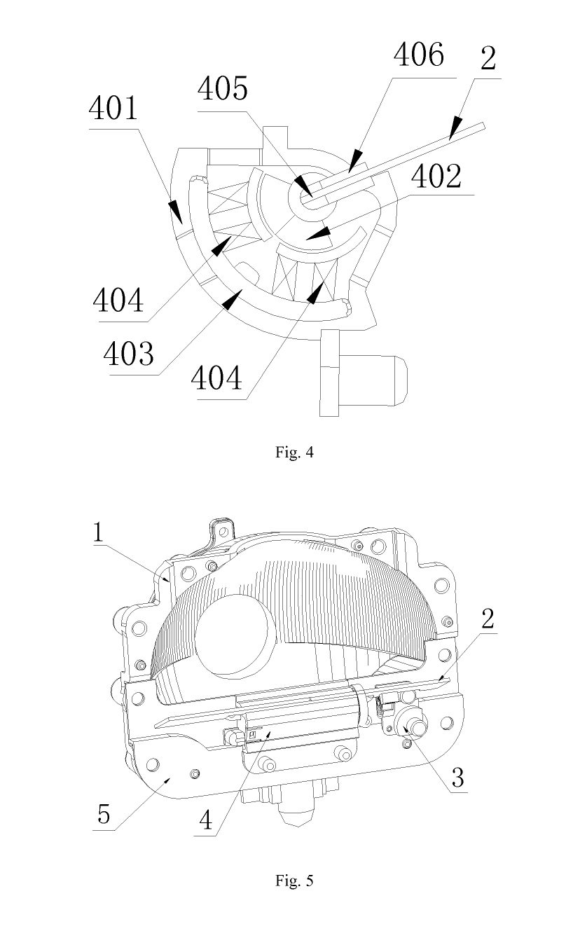

One embodiment of the rotary electromagnetic actuator of the invention is shown as FIG. 2 and FIG. 3; FIG. 4 is the structural representation that the rotary electromagnetic actuator of the invention drives the light screen to rotate to the action position. In the embodiment of the rotary electromagnetic actuator shown in the attached drawings, it includes a shell 401, a rotor, 402, a stator 403, a rotating shaft 405, an end cover 407, and a light screen 2 used for driving the car lamp low beam and high beam light switching device. In order to more clearly express the internal structure of the rotary electromagnetic actuator 4 of the invention, the end cover 407 is omitted in FIG. 3 and FIG. 4.

a stator winding 403 is arranged on the stator 404, and the stator 403 and the stator winding 404 are fixedly mounted in the shell to form a pair of arc-shaped stator magnetic poles on which electric excitation can be applied;

the rotor 402, as an arc-shaped permanent magnet, is fixed on the rotating shaft 405 and is located in a magnetic field space of the arc-shaped magnetic poles of the stator; and the rotor 402 is matched with the arc-shaped stator magnetic poles to form an air gap closing magnetic path;

an swing bar 406 extending along radial direction of the rotating shaft 405 is connected to two ends of the rotating shaft respectively; the light screen of the car lamp low beam and high beam light switching device is fixedly connected on the swing bars 406 at two ends of the rotating shaft; and a swing angle of the light screen 2 is identical with a rotating angle of the rotor 402.

According to the embodiment of the rotary electromagnetic actuator of the invention shown in FIG. 2, FIG. 3 and FIG. 4, the rotor 402 of the electromagnetic actuator 4 is rotatably fixed in the magnetic field space of the arc-shaped magnetic poles of the stator 403 through a shaft hole 408 on the end cover 407; under an uncharged state, the rotor stops on an initial position where the permanent magnet is relative to one of the magnetic poles of the stator as FIG. 3; and under a charged state, the rotor rotates to an acting position where the permanent magnet is relative to the pair of the magnetic poles of the stator under the function of a magnetic field generated by the stator winding as FIG. 4.

According to a better embodiment of the rotary electromagnetic actuator of the invention, the permanent magnet of the rotor 402 is integrally injection-molded with the rotating shaft 405 and the swing bars 406.

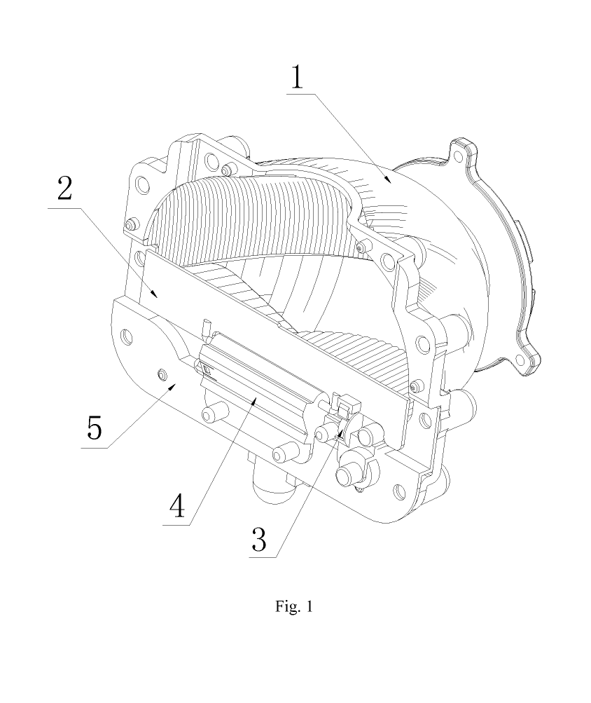

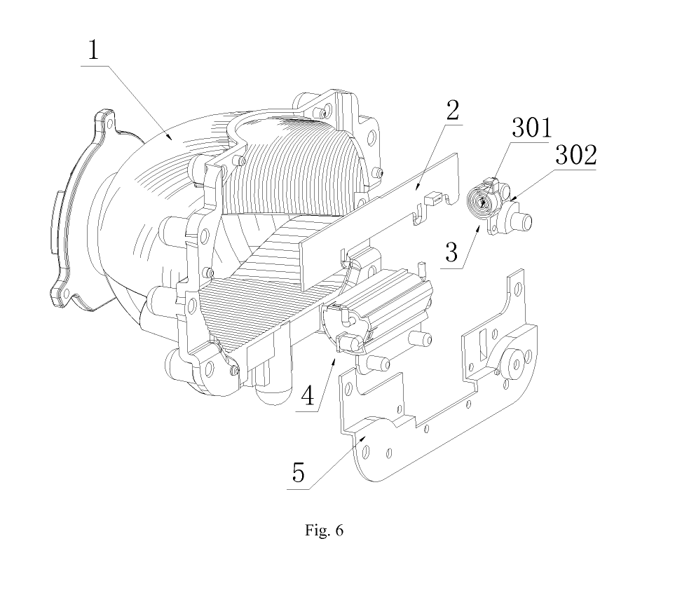

FIG. 1, FIG. 5 and FIG. 6 represent one embodiment of the car lamp low beam and high beam light switching device adopting the rotary electromagnetic actuator of the invention; it comprises a light screen 3, a electromagnetic actuator 4 and a bracket 5 fixed on the lamp body 1. The lamp body is generally combined with the reflection mirror, so it is also called as the reflection mirror. The electromagnetic actuator 4 is rotary electromagnetic actuator, and both ends of the rotating shaft 405 of the rotary electromagnetic actuator 4 are respectively connected with one swing bar 406 extended along the radial direction of the rotating shaft. The electromagnetic actuator 4 is fixed on the bracket 5 through the shell 401, and connected to the lamp body 1 through the bracket 5.

The light screen 2 is fixedly connected to the swing bar 406, and placed on the light axial line of the lamp; the included angle between the light screen 2 and the light axial line can be changed along with the rotating angle of the rotor 402; the outline of the light screen is projected on the road to form the light model of the low beam and high beam light changed along with the rotor 402.

According to one embodiment of the car lamp low beam and high beam light switching device of the invention, the light screen 2 is welded with the rotating shaft 405 and the swing bar 406 into one.

According to a preferable embodiment of the car lamp low beam and high beam light switching device of the invention, the car lamp low beam and high beam light switching device further comprises a scroll spring 301 and a spring component 3 consisting of spring frames 302; the spring component 3 is fixed on the bracket through the spring frame 302, a free end of the scroll spring 301 is connected to the light screen 2; under an uncharged state, the rotor is returned and kept at the initial position under the action of the scroll spring 301 through the transmission of the swing bar 406 and the rotating shaft 405.

1. A rotary electromagnetic actuator, comprising a shell, a rotor, a stator, a rotating shaft and an end cover, and used for driving a light screen of a car lamp low beam and high beam light switching device, wherein:
a stator winding is arranged on the stator, and the stator and the stator winding are fixedly mounted in the shell to form a pair of arc-shaped stator magnetic poles on which electric excitation can be applied;
the rotor, as an arc-shaped permanent magnet, is fixed on the rotating shaft and is located in a magnetic field space of the arc-shaped magnetic poles of the stator; and the rotor is matched with the arc-shaped stator magnetic poles to form an air gap closing magnetic path;
an swing bar extending along radial direction of the rotating shaft is connected to two ends of the rotating shaft respectively; the light screen of the car lamp low beam and high beam light switching device is fixedly connected on the swing bars at two ends of the rotating shaft; and a swing angle of the light screen is identical with a rotating angle of the rotor.

2. The rotary electromagnetic actuator according to claim 1, wherein the rotor of the electromagnetic actuator is rotatably fixed in the magnetic field space of the arc-shaped magnetic poles of the stator through a shaft hole on the end cover; under an uncharged state, the rotor stops on an initial position where the permanent magnet is relative to one of the magnetic poles of the stator; and under a charged state, the rotor rotates to an acting position where the permanent magnet is relative to the pair of the magnetic poles of the stator under the function of a magnetic field generated by the stator winding.

3. The rotary electromagnetic actuator according to claim 1, wherein the permanent magnet of the stator is integrally injection-molded with the rotating shaft and the swing rods.

4. A car lamp low beam and high beam light switching device, comprising a light screen, a electromagnetic actuator, and a bracket fixed on the lamp body, wherein:
the electromagnetic actuator is the rotary electromagnetic actuator according to claim 1; both ends of the rotating shaft of the electromagnetic actuator are respectively connected with one swing bar extended along the radial direction of the rotating shaft;
the rotary electromagnetic actuator is fixedly connected to the bracket through the shell, and connected to the lamp body through the bracket;
the light screen is fixedly connected to the swing bar, and placed on the light axial line of the lamp; the included angle between the light screen and the light axial line can be changed along with the rotating angle of the rotor; the outline of the light screen is projected on the road to form the light model of the low beam and high beam light changed along with the rotor.

5. The car lamp low beam and high beam light switching device according to claim 4, characterized in that the light screen is welded with the rotating shaft and the swing bar into one.

6. The car lamp low beam and high beam light switching device according to claim 4, characterized in that the device further comprises a scroll spring and a spring component consisting of spring frames; the spring component is fixed on the bracket through the spring frame, a free end of the scroll spring is connected to the light screen; under an uncharged state, the rotor is returned and kept at the initial position under the action of the scroll spring through the transmission of the swing bar and the rotating shaft.
